(19) United States
(12) Patent Application Publication
(10) Pub. No.: US 2010/0215909 A1
(43) Pub. Date: Aug. 26, 2010

(54) Photomask for the Fabrication of a Dual Damascene Structure and Method for Forming the Same

(76) Inventor: Susan S. MacDonald, Georgetown, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/064,454

(22) PCT Filed: Sep. 6, 2006
(86) PCT No.: PCT/US06/34697

§ 371 Date: Feb. 21, 2008

Related U.S. Application Data
(60) Provisional application No. 60/717,627, filed on Sep. 15, 2005.

(51) Int. Cl. B32B 3/00; B44C 1/22

(52) U.S. Cl. 428/172; 216/41

(57) ABSTRACT

A photomask for the fabrication of dual damascene structures and a method for forming the same are provided. A method for fabricating a multilayer step-and-print lithography (SFIL) template includes providing a blank having a substrate, an absorber layer and a first resist layer. A metal layer pattern of a dual damascene structure is formed in the substrate at a first depth using a lithography system. The first resist layer is removed from the blank and a second resist later is applied. The lithography system is used to form a via layer pattern of the dual damascene structure at the first depth while the metal layer pattern is simultaneously etched to a second depth.

### CROSS-REFERENCE TO RELATED APPLICATIONS

This application is a U.S. national stage application of International Application No. PCT/US2006/034697 filed Sep. 6, 2006, which designates the United States of America, and claims priority to U.S. Provisional Application Ser. No. 60/714,627 filed Sep. 7, 2005, the contents of which are hereby incorporated by reference in their entirety.

### TECHNICAL FIELD

This disclosure relates in general to step-and-flash imprint lithography and, more particularly, to a photomask for the fabrication of a dual damascene structure and method for forming the same.

### BACKGROUND

As device manufacturers continue to produce smaller and more complicated devices, photomasks used to fabricate these devices continue to require a wider range of capabilities. Advanced microprocessors may require eight or more levels of wiring to transmit electrical signals and power among devices and to external circuitry. Each wiring level may connect to the levels above and below it through via layers.

In a standard dual damascene process, only a single metal deposition step may be used to simultaneously form a metal layer and a via layer. The vias and the trenches may be defined using two lithography steps and at least two etch steps. After the via and trench recesses are etched, the via may be filled with a metal material in the same step used to fill the trench defining the metal layer. The excess metal deposited outside of the trench may be removed by a chemical mechanical polishing (CMP) process such that a planar structure with metal inlays is formed. Once the planarized surface is achieved, a CMP does not have to be performed on the dielectric layer. Thus, a CMP step may be eliminated through use of the dual damascene process.

A step-and-flash imprint lithography (SFIL) process uses a template similar to a mold to form a pattern on a substrate. A polymerizable fluid may be deposited on a substrate surface and the fluid may fill the gaps defined by a relief pattern in the template when the template is applied to the fluid on the wafer. The polymerizable fluid may be solidified to form a mask on the device such that a pattern may be formed on the device. An SFIL processes may have advantages over other lithographic techniques, such as offering a high resolution, excellent pattern fidelity, and the ability to be utilized at room temperature and low pressure. However, a standard SFIL template may only be used to form a single device layer.

### SUMMARY OF THE DISCLOSURE

In accordance with teachings of the present disclosure, disadvantages and problems associated with a forming a dual damascene photomask have been substantially reduced or eliminated. In a particular embodiment, a multi-layer template is formed using a combination of chrome and resist as etch stop layers during a substrate etch.

In accordance with one embodiment of the present disclosure, a method is provided for forming a step-and-flash imprint lithography (SFIL) template. A blank is provided including a substrate, an absorber layer, and a first resist layer. A metal layer pattern of a dual damascene structure is formed in the substrate at a first depth using a lithography system. The first resist layer is removed from the blank and a second resist later is applied. A lithography system is used to form a via layer pattern of the dual damascene structure at the first depth while the metal layer pattern is simultaneously etched to a second depth.

In accordance with another embodiment of the present disclosure, a method for fabricating an SFIL template includes providing a blank having a substrate, an absorber layer and a first resist layer including a first pattern formed therein to expose first portions of the absorber layer. The exposed first portions of the absorber layer are etched to expose first portions of the substrate and the exposed first portions of the substrate are etched to form the first pattern in the substrate. The absorber layer functions to provide a first etch stop during etching of the first portions of the substrate. A second resist layer is deposited on the etched first portions of the substrate and exposed first portions of the absorber layer. A second pattern is developed in the second resist layer to expose second portions of the absorber layer. The exposed second portions of the absorber layer are etched to expose second portions of the substrate such that the second portions of the substrate include the etched first portions of the substrate. The exposed second portions of the substrate are etched to form the second pattern in the substrate. The absorber layer functions to provide a second etch stop during etching of the second portions of the substrate. The absorber layer and the second resist layer are removed to form a multi-layer SFIL template.

In accordance with another embodiment of the present disclosure, a multi-layer SFIL template includes a substrate, a first trench formed in the substrate at a first depth and a second trench formed in the substrate at a second depth. The first trench corresponds to a metal layer of a dual damascene structure on a semiconductor wafer using an SFIL process and the second trench corresponds to a via layer of the dual damascene structure. The first and second trenches are formed in the substrate by etching the substrate and using an absorber layer as an etch stop.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIGS. 1A-1J illustrate cross-sectional side views of a semiconductor wafer at various stages of manufacturing a dual damascene structure in accordance with teachings of the prior art;

FIGS. 2A-2E illustrate cross-sectional side views of a semiconductor wafer at various stages of manufacturing a dual damascene structure using a step-and-print imprint lithography (SFIL) process according to teachings of the present disclosure;

FIG. 3A illustrates a top view of an SFIL template for use with an SFIL process to create a dual damascene structure on a semiconductor wafer according to teachings of the present disclosure;

FIG. 3B illustrates a cross-sectional side view of the SFIL template of FIG. 3A according to teachings of the present disclosure;

FIG. 4 illustrates a flow diagram for a method of fabricating a multi-layer SFIL template according to the teachings of the present disclosure;

FIG. 5A illustrates a top view of design data included in a mask pattern file used to fabricate a multi-layer SFIL template according to teachings of the present disclosure; and

FIG. 5B-5E illustrate cross-sectional side views of an SFIL template at various stages of manufacturing the SFIL template according to teachings of the present disclosure.

### DETAILED DESCRIPTION

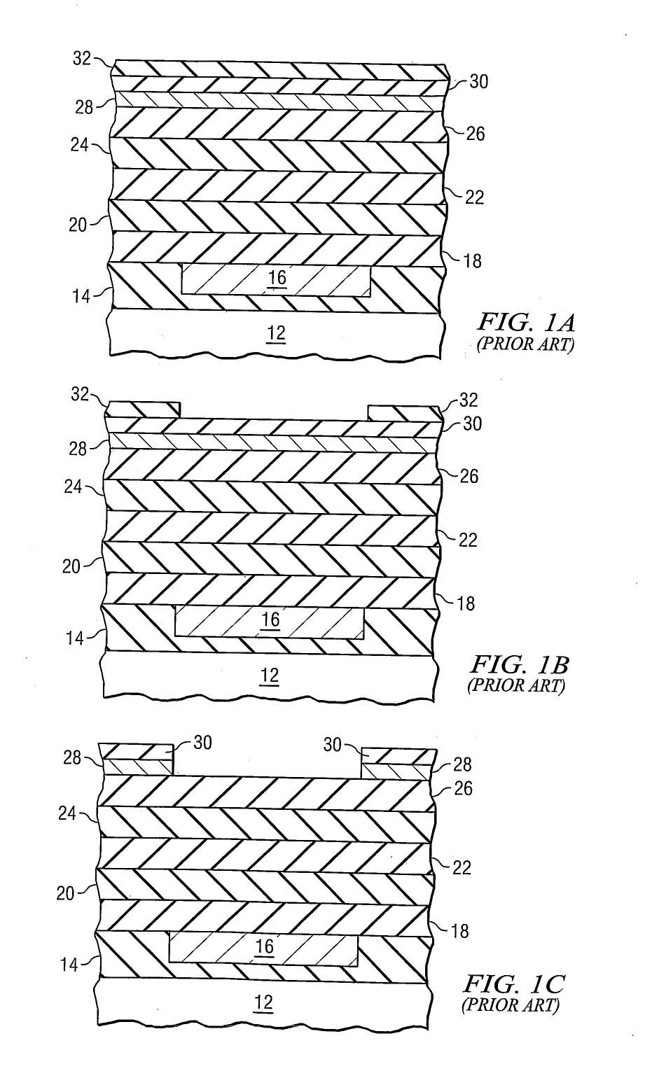

Preferred embodiments of the present disclosure and their advantages are best understood by reference to FIGS. 1 through 5, where like numbers are used to indicate like and corresponding parts.

FIGS. 1A through 1J illustrate cross-sectional side views of a semiconductor wafer at various stages of a conventional manufacturing process for a dual damascene structure. Some conventional manufacturing processes for a dual damascene structure may require greater than twenty steps to fabricate a single metal-via layer. In the illustrated embodiment, a conventional dual damascene process includes twenty-three processing steps in order fabricate a single metal-via layer. Assuming that an integrated circuit includes eight layers of metal, the total number of steps required to form all eight metal-via layers would be approximately 161.

FIG. 1A illustrates the first eight steps in a conventional manufacturing process for a dual damascene structure. Metal layer 16 may be formed in dielectric material 14 that is formed over a device layer (not shown) on semiconductor wafer 12. Metal layer 16 may be copper, aluminum or any other suitable metal that may be used to transmit electrical signals and power among devices in an integrated circuit. Dielectric layer 14 may be silicon dioxide (SiO₂), a low-k interlayer dielectric (ILD) or any other suitable material that may provide an insulation layer of the integrated circuit. Semiconductor wafer 12 may be silicon, gallium arsenide or any other suitable material used to form an integrated circuit.

In the first step of the manufacturing process, metal etch barrier 18, such as copper, may be deposited on metal layer 16 and dielectric layer 14. In the second step, via ILD layer 20 may be deposited on metal etch barrier 18. In the third step, trench etch stop layer 22 may be applied over via ILD layer 20. In the fourth step, metal ILD layer 24 may be deposited over trench etch stop layer 22. In the fifth step, via hard mask 26 may be applied over metal ILD layer 24 followed by deposition of trench hard mask 28 over via hard mask 26 in the sixth step. In one embodiment, the material used to form via and trench hard masks may be a plasma silicon nitride. In other embodiments, the trench hard mask may be any suitable material that provides protection for the ILD layer during a photoresist strip process and/or provides an etch stop during a chemical mechanical polishing (CMP) process. In the seventh step, bottom antireflective coat (BARC) layer 30 may be deposited over trench hard mask 28. BARC material may be organic or inorganic. In the eighth step, photoresist 32 may be deposited over BARC layer 30. Photoresist 32 may be any suitable positive or negative photoresist.

FIG. 1B illustrates the ninth and tenth steps in a conventional process for a dual damascene structure. In the ninth step, a trench of approximately the same size as metal layer 16 formed in dielectric layer 14 may be formed in photoresist 32 by exposing the photoresist using a photomask (not shown) and a lithography system (not shown). In the tenth step, photoresist 32 may be developed to expose BARC layer 30 and form a trench of approximately the size of metal layer 16 formed in dielectric layer 14. If a positive photoresist is used, the exposed portion of the resist may be developed and, if a negative photoresist is used, the unexposed portion of the resist may be developed.

FIG. 1C illustrates steps eleven and twelve in the conventional manufacturing process for a dual damascene structure. In step eleven, any suitable etch process may be used to etch through BARC layer 30 and trench hard mask layer 28 in the trench formed by removal of photoresist 32. The etch process may be an anisotropic dry etch or any other suitable etch process that removes the trench hard mask layer. In step twelve, an ash process may be used to remove any remaining photoresist 32. In one embodiment, the ash process may be conducted in a strongly oxidizing gaseous atmosphere.

FIG. 1D illustrates steps thirteen and fourteen in the conventional manufacturing process for a dual damascene structure. In step thirteen, second BARC layer 31 may be deposited in the trench over via hard mask layer 26 and over the remaining portions of trench hard mask 28. In step fourteen, second photoresist layer 34 may be formed over second BARC layer 31.

FIG. 1E illustrates steps fifteen through seventeen in the conventional manufacturing process for a dual damascene structure. In step fifteen, a via pattern may be imaged in photoresist 34 using a second photomask (not shown) and the lithography system (not shown). In step sixteen, photoresist 34 may be developed to form a via pattern in photoresist 34 and expose a portion of via hard mask 26. In step seventeen, the exposed portion of via hard mask layer 26 in the via may be etched to expose a surface of metal ILD layer 24.

FIG. 1F illustrates step eighteen in the conventional manufacturing process for a dual damascene structure. In step eighteen, any suitable etch process may be used to etch the exposed portion of metal ILD layer 24 in the via and the trench etch stop layer 22 in the via.

FIG. 1G illustrates step nineteen in the conventional manufacturing process for a dual damascene structure. In step nineteen, an ash process may be used to remove any remaining photoresist 34 and via ILD layer 20 in the trench defining the via may be removed by an etch process.

FIG. 1H illustrates step twenty in the conventional manufacturing process for a dual damascene structure. In step twenty, barrier layer 18 may be etched in the via to expose a surface of metal layer 16. In one embodiment, metal layer 16 may be copper.

FIG. 1I illustrates steps twenty-one and twenty-two in the conventional manufacturing process for a dual damascene structure. In steps twenty-one and twenty-two respectively, copper seed layer 36 may be deposited over the exposed surfaces and copper layer 37 may be plated over copper seed layer 36 formed in the via and over the exposed portions of trench etch stop layer 22 in the trench.

FIG. 1J illustrates step twenty-three in the conventional manufacturing process for a dual damascene structure. The metal-via layer may be completed by using a CMP process such that copper layer 37 formed in the trench is level with the remaining metal ILD layer 24 in step twenty-three. When the process is completed, via 38 and metal layer 39 may be created and may be electrically coupled to metal layer 16.

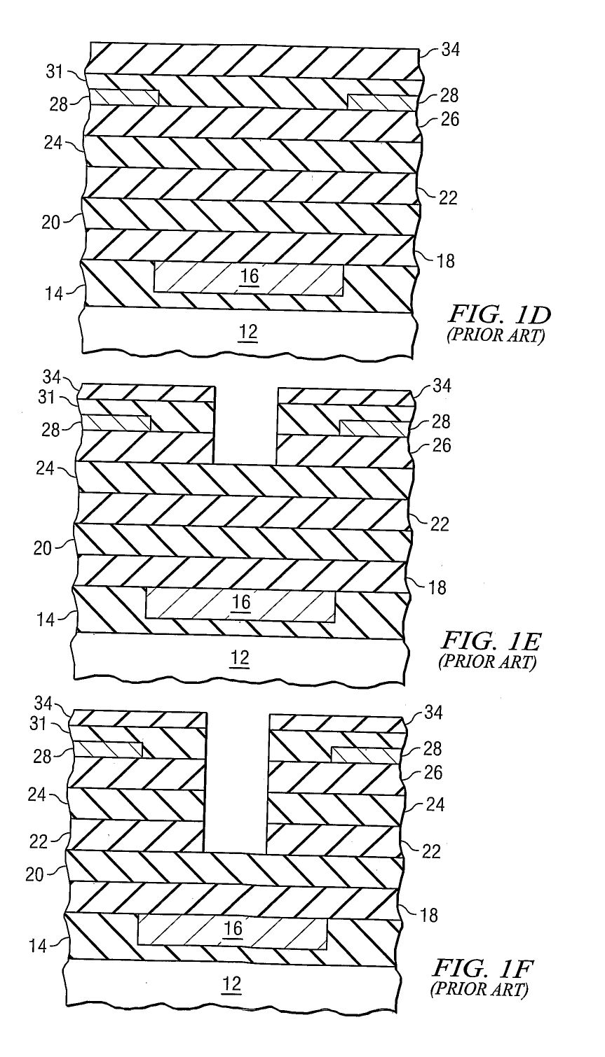

FIGS. 2A through 2E illustrate cross-sectional side views of a semiconductor wafer 52 and a step-and-print imprint lithography (SFIL) template 62 at various stages of an SFIL manufacturing process for a dual damascene structure. In an SFIL process, a template, for example SFIL template 62, may be used as a mold or stamp to form a pattern on a semiconductor wafer by contacting the template with a film, for example film 60, on the wafer. In one embodiment, the film may be a polymerizable fluid that has a low viscosity and is photocurable. When the template comes into contact with the film, the film may fill the spaces between the template and the surface of the semiconductor wafer. The film may then be solidified by either exposing it to light or to heat. The template may be released from contact with the film once the film is hardened and the appropriate structure on the wafer may be formed.

FIG. 2A illustrates the first two steps in an SFIL manufacturing process for a dual damascene structure in accordance with the present disclosure. Metal layer 56 may be formed in dielectric material 54 that is formed on semiconductor wafer 52. In one embodiment, metal layer 56 may be copper. Metal layer 56 and dielectric layer 54 may be similar to metal layer 16 and dielectric layer 14 described in reference to FIGS. 1A-1J. In the first step of the manufacturing process, metal etch barrier 58, such as copper, may be deposited on metal layer 56 and dielectric layer 54. In the second step, film 60 may be dispensed on etch barrier 58. In one embodiment, film 60 may be a resist material that acts as a dielectric that separates the various layers of an integrated circuit. For example, film 60 may be an imprintable dielectric material such as a polyhedral oligomeric silsesquixane (POSS) type material. In another embodiment, film 60 may be a polymerizable fluid, including but not limited to compounds including an organic acrylate, an organic crosslinker, a silicon containing acrylate, and/or a photoinitiator, or any other suitable compound.

FIG. 2B illustrates the third step in an SFIL manufacturing process for a dual damascene structure. In the third step, SFIL template 62 may be applied to film 60 on semiconductor wafer by, for example, applying pressure to SFIL template 62. In one embodiment, SFIL template 62 may be a transparent material such as quartz, synthetic quartz, fused silica, magnesium fluoride (MgF₂), calcium fluoride (CaF₂), or any other suitable material that transmits at least seventy-five percent (75%) of incident light having a wavelength between approximately 10 nanometers (nm) and approximately 450 nm. In another embodiment, SFIL template 62 may be an opaque material that retains its shape when heat is applied to either SFIL template 62 or semiconductor wafer 52. In the illustrated embodiment, film 60 may be cured by exposing SFIL template 62 to a radiation source such as an ultraviolet (UV) or deep ultraviolet (DUV) light. In another embodiment, film 60 may be cured by applying a heat source to either SFIL template 62 or semiconductor wafer 52. Once film 60 is sufficiently hardened, SFIL template 62 may be released. As illustrated, a thin layer of film 60 may be present in the via formed by the template.

FIG. 2C illustrates the fourth and fifth steps in an SFIL manufacturing process for a dual damascene structure. In the fourth step, an etch may be performed to remove the residual portion of film 60 remaining at the bottom of the via to expose barrier layer 58. The etch process may be any suitable process that removes a dielectric material. In the fifth step, an etch process may be performed to remove the portion of barrier layer 58 exposed by the via and expose a surface of metal layer 56. The etch process may be any suitable process that removes a metal barrier layer.

FIG. 2D illustrates the last three steps in an SFIL manufacturing process for a dual damascene structure. In the sixth and seventh steps respectively, copper seed layer 76 may be deposited over the exposed surfaces and copper layer 77 may be plated over copper seed layer 76 formed in the via and over the exposed portions of film 60 in the trench. The metal-via layer may be completed by using a CMP process such that copper layer 77 formed in the trench is level with the remaining film 60 in step eight. When the process is completed, via 78 and metal layer 79 may be created and may be electrically coupled to metal layer 56, as depicted in FIG. 2E.

An SFIL process, therefore, uses fewer steps to manufacture a dual damascene structure than a conventional manufacturing process. For example, an integrated circuit including eight layers of metal (e.g., seven metal-via layers) may require fifty-six steps if an SFIL process is used, in contrast with the 161 steps required by the conventional process described with respect to FIGS. 1A through 1J. By reducing the number of steps required, the time necessary to create an integrated circuit and the costs associated with the manufacturing process may be significantly reduced.

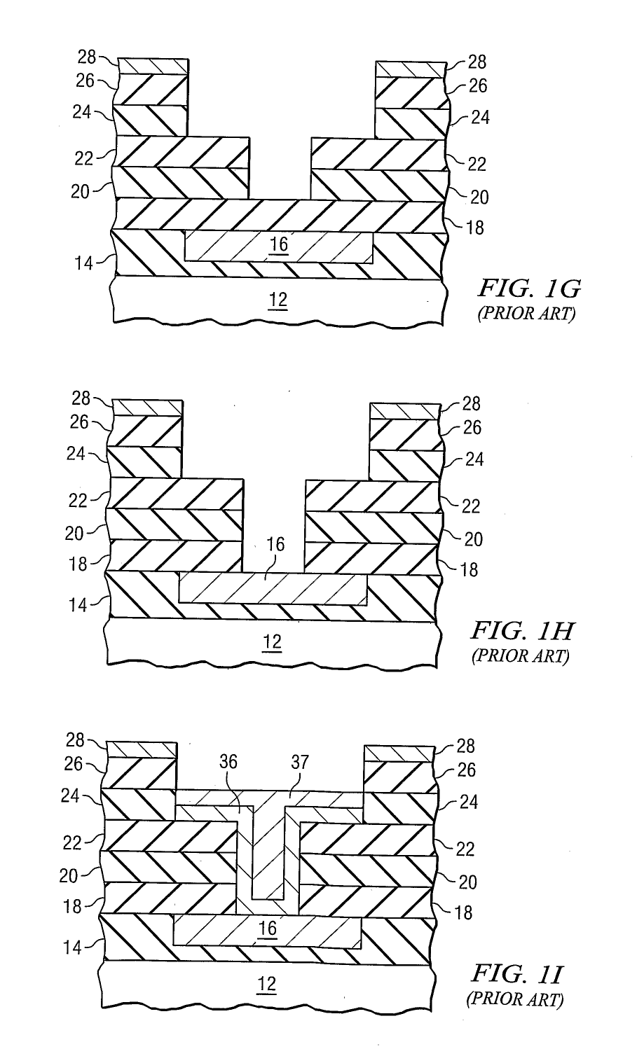

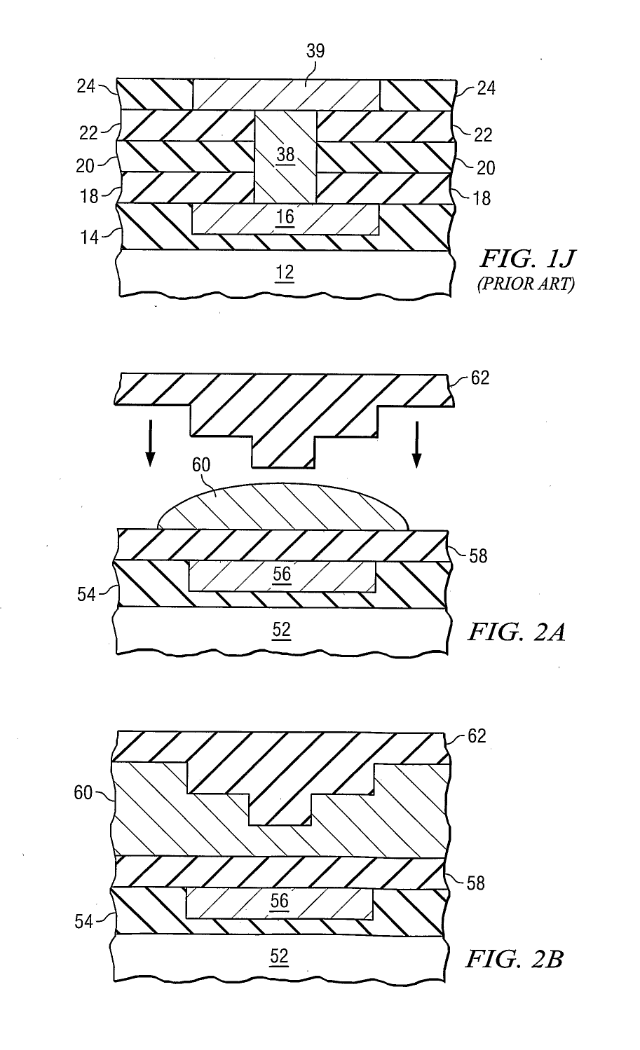

FIG. 3A illustrates a top view of multi-layer SFIL template 82 used to fabricate dual damascene structures on a semiconductor wafer and FIG. 3B illustrates an cross-sectional side view of SFIL template 82 shown in FIG. 3A. SFIL template 82 may include features 84, metal features 86 and via features 88. SFIL template 82 may be used in an SFIL process, for example with a dielectric material acting as the polymerizable fluid as described above in reference to FIGS. 2A through 2E. When applied to the film deposited on a semiconductor wafer, SFIL template 82 may be used to simultaneously form a via layer using via features 88 and a metal layer using metal features 86 on an exposed surface of a semiconductor wafer. Using SFIL template 82 with an SFIL process may reduce the number of steps required to form two layers in a device significantly.

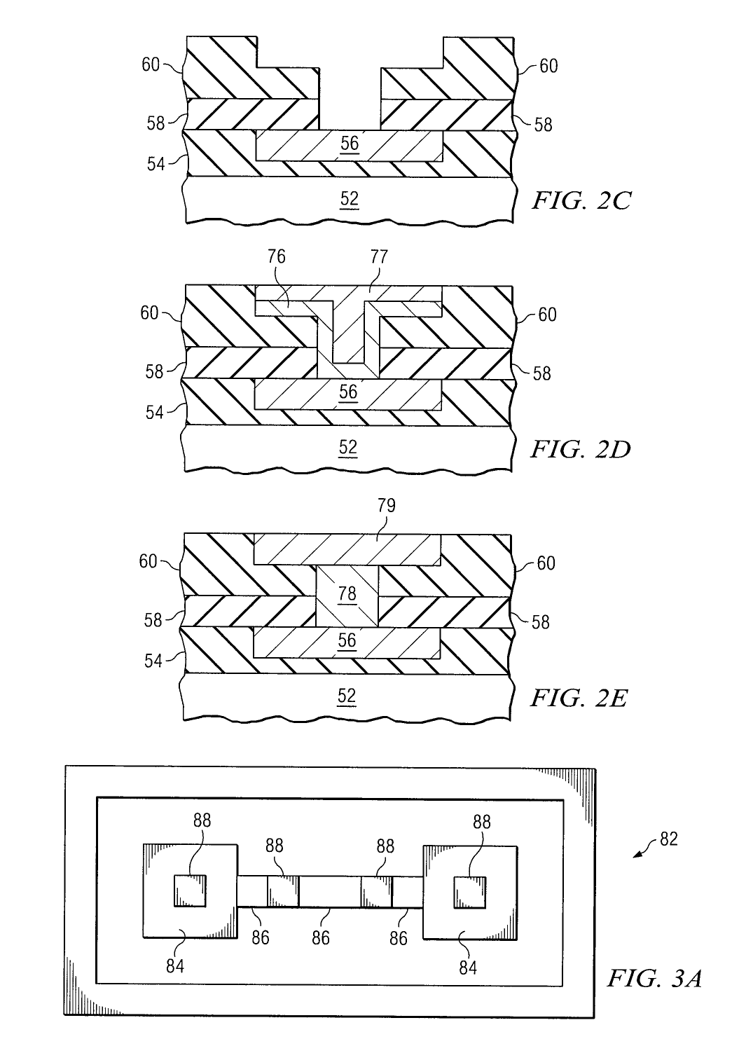

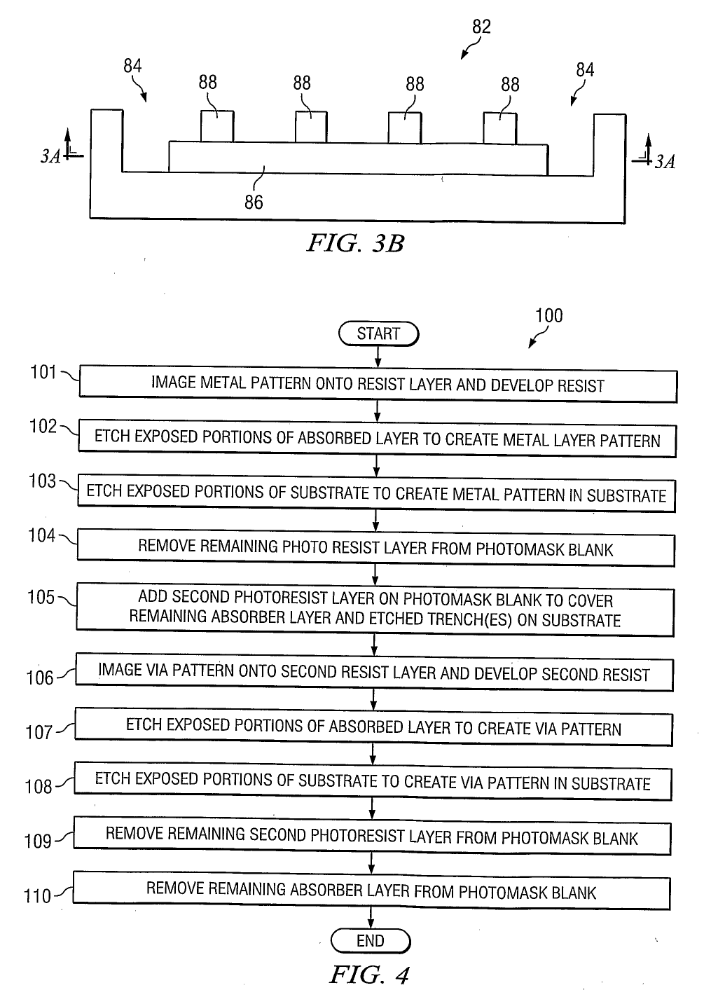

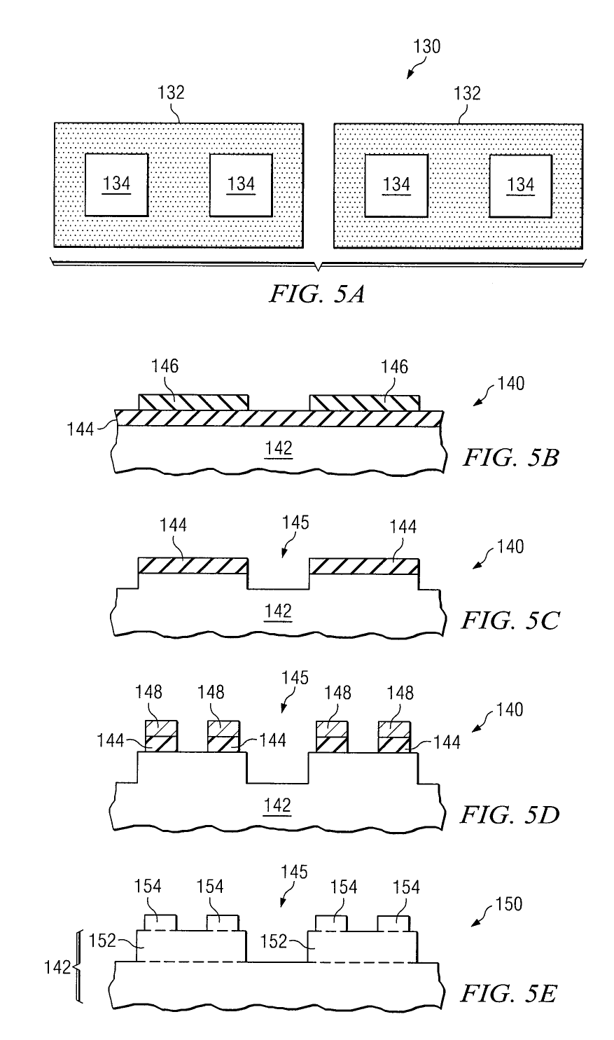

FIG. 4 illustrates a flow diagram for a method 100 of fabricating a dual damascene SFIL template, for example SFIL template 62 or 82. FIG. 5A illustrates design data 130 included in a mask pattern file used to fabricate a multi-layer SFIL template, for example SFIL template 62 or 82, in accordance with the teachings of the present disclosure. FIGS. 5B through 5E illustrate cross-sectional side views of an SFIL template, for example SFIL template 62 or 82, at various stages of manufacture in accordance with the present disclosure. Generally, photomask blank 140 including absorber layer 144 formed on substrate 142 and photoresist layer 146 formed on absorber layer 144 may be provided. Metal pattern 132 may be imaged into photoresist layer 146 using a mask pattern file and a lithography system. Once the exposed portion of resist layer 146 is developed, the exposed portion of absorber layer 144 may be etched. Metal pattern 132 may then be formed in substrate 142 by etching substrate 142 and using absorber layer 144 as an etch barrier. Another layer of photoresist 148 may be deposited on the surface of absorber layer 144 and additional trenches may be formed in substrate 142 in order to image via pattern 134 into photoresist 148 using another mask pattern file and a lithography system. Again, the exposed portion of absorber layer 144 may be etched once the exposed portion of resist layer 148 is developed to form via pattern 134 in absorber layer 144. The remaining portion of absorber layer 144 is used as an etch barrier to form via pattern 134 in substrate 142 by etching exposed portions of the substrate 142.

At step 101 of method 100, metal pattern 132 included in a mask pattern file may be imaged into photoresist layer 146 of photomask blank 140 by a lithography system. An example of metal pattern 132 for the metal layer of a dual damascene structure included in a mask pattern file is shown in FIG. 5A. Design data 130 may be included in one mask pattern file or metal pattern 132 and via pattern 134 may be included in separate mask pattern files. The desired pattern may be imaged into a resist layer of the photomask blank using a laser, electron beam or X-ray lithography system. In one embodiment, a laser lithography system uses an argon-ion laser that emits light having a wavelength of approximately 364 nanometers (nm). In alternative embodiments, the laser lithography system uses lasers emitting light at wavelengths from approximately 150 nm to approximately 300 nm. In other embodiments, a 25 keV or 50 keV electron beam lithography system uses a lanthanum hexaboride or thermal field emission source. In further embodiments, different electron beam lithography systems may be used.

Additionally, at step 101 of method 100, resist layer 146 may be developed to form metal pattern 132. Portions of absorber layer 144 that correspond to metal pattern 132 may be exposed by developing the exposed portions of resist layer 146 with an alkaline solution that removes either the exposed (positive photoresist) or the unexposed (negative photoresist) portion. The developer may be a metal-ion-free developer such as tetramethyl ammonium hydroxide (TMAH). In other embodiments, any suitable developer may be used. FIG. 5B illustrates photomask blank 140 after completion of step 101.

As discussed above, photomask blank 140 may include substrate 142, absorber layer 144, and photoresist layer 146. Substrate 142 may be a transparent material such as quartz, synthetic quartz, fused silica, magnesium fluoride (MgF₂), calcium fluoride (CaF₂), or any other suitable material. Absorber layer 144 may be a metal material such as chrome, chromium nitride, copper, a metallic oxy-carbo-nitride (e.g., MOCN, where M is selected from the group consisting of chromium, cobalt, iron, zinc, molybdenum, niobium, tantalum, titanium, tungsten, aluminum, magnesium, and silicon), or any other suitable material that provides an etch stop during a substrate etch step. In an alternative embodiment, absorber layer 144 may be formed of molybdenum silicide (MoSi). Resist layer 146 may be a polymethyl methacrylate (PMMA) resist, a polybutane 1-sulfone (PBS) resist, a polychloromethylstyrene (PCMS) resist, or any other suitable positive or negative resist.

At step 102 of method 100, the exposed portions of absorber layer 144 may be etched to create metal layer pattern 132 in absorber layer 144. In one embodiment, absorber layer 144 may be etched using a ferric perchloride (FeCl₃6H₂0) etch, any chloride containing (Cl₂) gas etch, an aqua regia etch, or any other suitable etch depending on the material used for absorber layer 144. The remaining resist layer 146 provides an etch stop for the etch process used to etch absorber layer 144.

At step 103 of method 100, the exposed portions of substrate 142 may be etched to create metal pattern 132 in substrate 142. In one embodiment, substrate 142 may be etched using a buffered oxygen etch, a potassium hydroxide (KOH) etch, or any other suitable etch. In some embodiments, the etch depth into substrate 142 may be approximately 500 nm. In other embodiments, the etch depth may be any suitable depth that provides the appropriate metal layer on a semiconductor wafer. At step 104 of method 100, the remaining portion of photoresist layer 146 may be removed from photomask blank 140. In another embodiment, the resist may be removed before the substrate etch. FIG. 5C illustrates photomask blank 140 after completion of step 104.

At step 105 of method 100, second photoresist layer 148 may be formed on photomask blank 140 to cover the remaining portion of absorber layer 144 and etched trench (or trenches) 145 in substrate 142. In one embodiment, second resist layer 148 may be an essentially identical compound as resist layer 146. In another embodiment, second resist layer 148 may be a different compound from that used to form first resist layer 146. Via pattern 134 included in a mask pattern file may then be imaged onto second resist layer 148 by a lithography system. An example pattern 134 for the via layer of a dual damascene structure included in a mask pattern file is shown in FIG. 5A. At step 106 of method 100, portions of absorber layer 144 that correspond to via pattern 134 may be exposed by developing the exposed portions of resist layer 148 with a solution that removes either the exposed (positive photoresist) or the unexposed (negative photoresist) portions.

At step 107 of method 100, the exposed portions of absorber layer 144 may be etched to expose portions of substrate 142 that correspond to via pattern 134. In one embodiment, the absorber etch process used to form via pattern 134 may be similar to the absorber etch process used to form metal pattern 132. In another embodiment, the absorber etch process used to form via pattern 134 may be different than the absorber etch process used to form metal pattern 134. FIG. 5D illustrates photomask blank 140 after completion of step 107.

At step 108 of method 100, the exposed portions of substrate 142 may be etched to form via pattern 134 in substrate 142. In one embodiment, the etch depth may be approximately 500 nm. In another embodiment, the etch depth may be any suitable depth that provides the appropriate via layer on a semiconductor wafer. In some embodiments, the first and second substrate etches may be approximately the same. For example, as illustrated in FIG. 3B, the trench formed by feature 84 may have a depth two times larger than the trench formed by metal feature 86. In other embodiments, the first and second substrate etches may be different such that the first etch is greater than the second etch or the second etch is greater than the first etch. At step 109 of method 100, the remaining portions of second resist 148 may be stripped and the remaining portions of absorber layer 144 may be stripped at step 110 of method 100. The resulting substrate 142 as depicted in FIG. 5E, may comprise an SFIL template 150 including via features 154 and metal features 152. The resulting SFIL template 150 may have features and characteristics similar to that of SFIL template 62. The above described process for fabricating an SFIL template provides aligned metal and via layers that are required for a dual damascene structure.

Other SFIL steps may also be used throughout the manufacturing process. For example, a release layer may be formed on the surface of SFIL templates 62, 82 and/or template 150 to allow reliable separation from a polymerizable fluid. A release layer may comprise a fluoroalkyltrichlorosilane precursor or any other suitable compound.

The use of an SFIL template, for example SFIL templates 62, 82 and/or 150, to create dual damascene features in a device may provide a number of advantages. In some embodiments, the number of steps required to form a device may be reduced significantly, since multiple layers may be formed in the device simultaneously. Another advantage may be the removal of several of the most difficult steps of prior art dual damascene approaches. Additionally, the use of a SFIL process may reduce alignment errors in a device, since a first layer and a connected second layer are formed simultaneously. Other advantages may be apparent to those of ordinary skill in the art.

Although the present disclosure as illustrated by the above embodiments has been described in detail, numerous variations will be apparent to one skilled in the art. For example, various cleaning and metrology steps may be'added. Additionally, certain steps may be performed in an alternate order. For example, the substrate may be etched after the resist is stripped. The materials, sizes, and shapes may also be varied depending on specific needs. It should be understood that various changes, substitutions and alternations can be made herein without departing from the spirit and scope of the disclosure as illustrated by the following claims.

What is claimed is:

1. A method for fabricating a multi-layer step-and-flash imprint lithography (SFIL) template, comprising:
providing a blank including a substrate, an absorber layer and a first resist layer;
using a lithography system to form a metal layer pattern of a dual damascene structure in the substrate at a first depth;
removing the first resist layer from the blank;
adding a second resist layer on the blank; and
using a lithography system to form a via layer pattern of the dual damascene structure at the first depth while simultaneously forming the metal layer pattern at a second depth.

2. The method of claim 1, wherein using a lithography system to form the metal layer pattern comprises:
using the lithography system to form the metal layer pattern in the first resist layer to expose portions of the absorber layer;
etching the exposed portions of the absorber layer to expose portions of the substrate; and
etching the exposed portions of the substrate to form the metal pattern in the substrate.

3. The method of claim 2, wherein the absorber layer is operable to provide an etch stop during etching of the portions of the substrate.

4. The method of claim 1, wherein using a lithography system to form the via layer pattern comprises:
using the lithography system to form the via layer pattern in the second resist layer to expose portions of the absorber layer;
etching the exposed portions of the absorber layer to expose portions of the substrate; and
etching the exposed portions of the substrate to form the via pattern in the substrate.

5. The method of claim 4, wherein the absorber layer is operable to provide an etch stop during etching of the portions of the substrate.

6. The method of claim 4, wherein the second resist layer is operable to provide an etch stop during etching of the exposed portion of the absorber layer.

7. The method of claim 1, wherein the absorber layer is operable to provide a first etch stop during the formation of the metal layer pattern in the substrate.

8. The method of claim 1, wherein the absorber layer is operable to provide a second etch stop during the formation of the via layer pattern in the substrate.

9. The method of claim 1, wherein the second depth is approximately two times greater than the first depth.

10. The method of claim 1, wherein the first and second depths are between approximately 10 nm and approximately 50 nm.

11. The method of claim 1, wherein the first and second depths are between approximately 50 nm and approximately 100 nm.

12. The method of claim 1, wherein the first and second depths are between approximately 100 nm and approximately 500 nm.

13. The method of claim 1, wherein the first and second depths are between approximately 500 nm and approximately 2000 nm.

14. (canceled)

15. A method for fabricating a multi-layer step-and-flash imprint lithography (SFIL) template, comprising:
providing a blank including a substrate, an absorber layer and a first resist layer including a first pattern formed therein to expose first portions of the absorber layer;
etching the exposed first portions of the absorber layer to expose first portions of the substrate;
etching the exposed first portions of the substrate to form the first pattern in the substrate, the absorber layer operable to provide a first etch stop during etching of the first portions of the substrate;
depositing a second resist layer on the etched portions of the substrate and exposed first portions of the absorber layer;
developing a second pattern in the second resist layer to expose second portions of the absorber layer;
etching the exposed second portions of the absorber layer to expose second portions of the substrate, the second portions of the substrate including the first portions of the substrate;
etching the exposed second portions of the substrate to form the second pattern in the substrate, the absorber layer operable to provide a second etch stop during etching of the second portions of the substrate; and
removing the absorber layer and the second resist layer to form a multi-layer SFIL template.

16. The method of claim 15, wherein:
the first portions of the substrate have a first depth; and
the second portions of the substrate have a second depth, the first depth approximately two times greater than the second depth.

17. The method of claim 15, wherein:
the first pattern corresponds to a metal layer in a dual damascene structure; and
the second pattern corresponds to a via layer in the dual damascene structure.

18. (canceled)

19. The method of claim 15, wherein the absorber layer comprises a material selected from the group consisting of chrome, chromium nitride, copper and a metallic oxy-carbo-nitride.

20. (canceled)

21. (canceled)

22. The method of claim 15, wherein the first resist layer is operable to provide an etch stop during etching of the first exposed portions of the absorber layer.

23. The method of claim 15, wherein the second resist layer is operable to provide an etch stop during etching of the second exposed portions of the absorber layer.

24. A multi-layer SFIL template, comprising:
a substrate;
a first trench formed in the substrate at a first depth, the first trench corresponding to a metal layer of a dual damascene structure on a semiconductor wafer using an SFIL process; and
a second trench formed in the substrate at a second depth, the second trench corresponding to a via layer of the dual damascene structure;
the first and second trenches formed in the substrate by etching the substrate and using an absorber layer as an etch stop.

25. The template of claim 24, wherein the first depth is approximately two times greater than the second depth.

26. (canceled)

27. The method of claim 24, wherein the absorber layer comprises a material selected from the group consisting of chrome, chromium nitride, and copper.

28. The template of claim 24, wherein the absorber comprises a metallic oxy-carbo-nitride.

29. The template of claim 28, wherein the metallic component of the metallic oxy-carbo-nitride is selected from the group consisting of chromium, cobalt, iron, zinc, molybdenum, niobium, tantalum, titanium, tungsten, aluminum, magnesium, and silicon.

30. The template of claim 24, further comprising the first and second trenches formed in the substrate by etching the absorber layer and using a resist layer as an etch stop.
